(19) United States
(12) Patent Application Publication
(10) Pub. No.: US 2025/0342832 A1
(43) Pub. Date: Nov. 6, 2025

(54) Wake-Word Processing in an Electronic Device

(71) Applicant: Stryker Corporation, Kalamazoo, MI (US)

(72) Inventors: Hari Puvvadi, Portage, MI (US); Swetang Sharma, Portage, MI (US); Prakash Guda, Portage, MI (US)

(21) Appl. No.: 18/854,369

(22) PCT Filed: Jan. 12, 2023
(86) PCT No.: PCT/US2023/060512

§ 371 Date: Oct. 4, 2024

Related U.S. Application Data
(60) Provisional application No. 63/362,640, filed on Apr. 7, 2022.

(51) Int. Cl. G10L 15/22

(52) U.S. Cl. CPC G10L 15/22

(57) ABSTRACT

Wake-word processing by a wearable electronic device could be carried out when the device is worn by a user and is in a device sleep state, the device including a linear microphone array having at least two microphones vertically spaced from each other, and the device also including a processor. And the example method could involve (i) the at least two microphones of the linear microphone array receiving an audio waveform representing a wake-word utterance, (ii) the processor making a determination, based at least on an angle of arrival of the audio waveform at the at least two microphones of the linear microphone array and/or an energy level of the audio waveform received at the at least two microphones of the linear array, of whether to accept the wake-word utterance or rather to reject the wake-word utterance, and (iii) the processor controlling operation of the device based on the determination.

### REFERENCE TO RELATED APPLICATION

This application claims priority to U.S. Provisional Patent Application No. 63/362,640, filed Apr. 7, 2022, the entirety of which is hereby incorporated by reference.

### BACKGROUND

Providing patient care in healthcare facilities (e.g., hospitals) generally necessitates interaction between healthcare workers (e.g., doctors, nurses, pharmacists, technicians, nurse practitioners, etc.) and between those healthcare workers and various devices/systems that support treatment of patients.

Many healthcare facilities have already installed one or more wireless networks to support wireless communication devices such as laptop computers and mobile phones that could facilitate this interaction. These wireless networks typically use standard wireless networking protocols, such as one of the 802.11 standards, with wireless access points distributed throughout the facilities and coupled with each other and/or with other network nodes using wireless mesh networking and/or wired (e.g., Ethernet) networking. When in coverage of such a network, healthcare workers may thus use their wireless communication devices in a conventional manner, to engage in calls with each other and perhaps to communicate with a centralized healthcare management system, among other possibilities.

### SUMMARY

One challenge that healthcare workers could face when using conventional wireless communication devices to communicate with each other and with supporting systems in typical healthcare facilities is that it may be inconvenient or impractical for the healthcare workers to hold and operate those devices as they go about their business. Even though some devices may support hands-free communication, a user may still need to hold and physically interact with the device to engage in certain functions such as powering on the device, dialing calls, or the like. For instance, a user may need to hold the device while interacting with a graphical user interface on a screen of the device and/or with a physical keypad or other such interface of the device.

As presently contemplated, a solution to this problem is to equip healthcare workers with specialized communication devices that rely largely on voice interaction. Such a device could be small, portable, and lightweight, configured to be worn by a healthcare worker (e.g., clipped to a shirt collar or worn on a neck-strap), and could operate in an always-on state, enabling the healthcare worker to quickly and conveniently place and receive calls, receive alerts, and interact with supporting systems, all without a need to hold the device and with minimal or no need to even touch the device.

Representative healthcare facilities could be configured with a communication system and associated systems that support use of such devices, and each healthcare worker could wear and use one of the devices. In particular, the communication system could include a wireless network having one or more wireless access points that the devices could communicate with using a standard or proprietary wireless communication protocol. And the communication system could include a central computing system that the devices could communicate with through the network and that controls and/or facilitates various communication operations. The healthcare workers could then conveniently make use of their devices to place and receive calls with each other and to engage in communication with the central computing system, to facilitate accessing healthcare information, receiving or sending messages, indications, or alerts, and engaging in other communications.

A representative communication device, also referred to as a “user device” or electronic device, could be powered by a rechargeable battery and could include one or more microphones for receiving voice or other audio input and one or more speakers and/or other interfaces for outputting voice or other audio. Further, the device could include one or more LEDs, haptic actuators, and/or other mechanisms for presenting visual, haptic, or other indications or alerts to the user. And the device could include a WiFi communication module or other wireless communication module to enable the device to communicate with the central computing system.

When such a device powers on within the healthcare system or otherwise enters into the healthcare system, the device may use its WiFi module to scan for WiFi coverage and may acquire WiFi connectivity with a nearby access point, and the device may then engage in signaling through the network with the central computing system, to register its presence and active state in the system. Once the device is so connected and registered, the device may then engage in communications with and through the central computing system, to facilitate communicating with other users and with associated systems.

In an example implementation, the device could be configured to receive voice commands from its user and to convey those voice commands to the central computing system for processing. For example, to initiate a voice call to another user, the user may speak call-initiation voice command designating a name of the other user, the device may responsively convey that voice command to the central computing system, and the central computing system may then engage in signaling to set up the requested voice call to the other user and may bridge the call, enabling the users to talk with each other. As another example, to request assistance or action to serve a patient, the user may speak an associated voice command expressing the request, the device may responsively convey that voice command to the central computing system, and the central computing system may process the request for assistance, perhaps conveying the request to one or more associated users and/or departments for handling.

One technical issue that could arise in practice with such a device is that providing “always-on” service could result in significant battery drain.

To help address this issue, the device could be configured to operate discontinuously, by transitioning to a low-power sleep state after a period of inactivity and/or upon leaving WiFi coverage for instance, and then transitioning back to a full-power state in response to certain triggers, such as periodically and/or upon receipt of an incoming message or upon user utterance of a wake word (e.g., word or phrase).

While within WiFi coverage, for instance, the device could transition to a low-power sleep state in which the device powers off or otherwise reduces power consumption of its host processor and various other components, including putting its WiFi module into a sleep state in which the WiFi module wakes up periodically in accordance with a protocol to check for any incoming unicast or multicast traffic. From that state, the device could then transition back to full-power state in response to receiving a unicast or multicast WiFi packet that may carry or precede an alert, message, call, or other signal from the central computing system, and the device could also transition at least partly back to the full-power state periodically to send a heartbeat message to the central computing system, to inform the central computing system that the device remains actively connected.

Whereas, when the device leaves WiFi coverage, the device could transition to a low-power sleep state in which the device powers off or otherwise reduces power consumption of its host processor and other components including the device's WiFi module. From this state, the device could then transition back to full-power state periodically to newly scan for WiFi coverage, i.e., to determine if the device has re-entered WiFi coverage. Further, the device could likewise transition back to the full-power state and scan for WiFi coverage when the device detects user utterance of the wake word. Upon newly finding WiFi coverage, the device could then reacquire WiFi connectivity and remain in the full-power state until transitioning once again to the sleep state.

Unfortunately, however, this discontinuous operation may itself also give rise to another technical issue.

In particular, when the device is in the low-power sleep state, whether in or out of WiFi coverage, at issue is how the device could detect when its user utters the wake word, in response to which the device would then transition back to the full-power state. There are at least two related questions. One is how to efficiently control power of the device in relation to detecting and responding to the wake word when the device is in the low-power state. And the other is how to ensure that the wake word is uttered by the user of the device rather than by another nearby user, i.e., to avoid waking up the device in response to another nearby user uttering the wake word.

Disclosed herein is a technical solution that may help to address this issue. In accordance with the disclosure, when the device is operating in the low-power sleep state, the device's host processor and other components could be powered down or in a low-power-consumption state, and the device could apply a low-power voice-recognizer module to detect utterance of the wake word and to responsively wake up the host processor. In response, the host processor could then evaluate the received audio of the wake word utterance to determine whether the wake word was spoken by the user of the device as opposed to another user and, based on that determination, could then control whether to proceed with transitioning the device to the full-power state including powering on other components of the device.

To facilitate this, the device could include a linear array of microphones for receiving audio input, and when the device is worn by the user, that linear array could be vertically oriented, so that audio coming from the wearing user would arrive with different phases at different microphones of the array. With this arrangement, the host processor could receive at least two audio channels of the wake-word utterance, each from a separate microphone of the linear array, and the host processor could use phases and/or energy levels of those audio channels as a basis to determine whether the wake word was spoken by the wearing user. If the host processor thereby determines that the wake word was spoken by the wearing user, then the host processor could proceed to fully or partially power-up the device. Whereas, if the host processor thereby determines that the wake word was not spoken by the wearing user, then the host processor could discard the utterance and could go back to the sleep state.

These as well as other aspects, advantages, and alternatives will become apparent to those of ordinary skill in the art by reading the following detailed description, with reference, where appropriate, to the accompanying drawings. In the drawings, similar symbols typically identify similar components, unless context dictates otherwise.

### BRIEF DESCRIPTION OF THE FIGURES

FIG. 1 is a simplified illustration of an example communication system in which an example user device may operate.

FIG. 2 is a simplified block diagram depicting example application programs in a central computing system operable in the system of FIG. 1.

FIG. 3A illustrates a left/front side perspective view of an example user device.

FIG. 3B illustrates a right/back side perspective view of the example user device.

FIG. 3C illustrates a right side view of the example user device.

FIG. 3D illustrates a left side view of the example user device.

FIG. 3E illustrates a top side view of the example user device.

FIG. 3F illustrates a bottom side view of the example user device.

FIG. 3G illustrates an exploded view of the example user device.

FIG. 3H illustrates a view of the example user device worn by an example user.

FIG. 4 is a simplified block diagram showing hardware components of the example user device.

FIG. 5 is a simplified block diagram illustrating example audio flow in an example user device.

FIG. 6 is an illustration of angle of arrival of audio at a linear microphone array of an example user device.

FIG. 7 is a flow chart depicting an example method for wake-word processing in an example user device.

FIG. 8 is another flow chart depicting an example method for wake-word processing in an example user device.

### DETAILED DESCRIPTION

Example systems, methods and apparatus are contemplated herein. Any example embodiment or feature described herein is not necessarily to be construed as preferred or advantageous over other embodiments or features. Further, the example embodiments described herein are not meant to be limiting. It will be readily understood that certain aspects of the disclosed systems, methods, and apparatus can be arranged and combined in a wide variety of different configurations, all of which are contemplated herein. In addition, the particular arrangements shown in the figures should not be viewed as limiting. It should be understood that other embodiments might include more or less of each element shown in a particular figure. Additionally, some of the illustrated elements may be combined or omitted. Yet further, an example embodiment may include elements that are not illustrated in the figures.

Example embodiments described herein relate to systems, methods, and apparatus for enabling communications in a communication system. The communication system could comprise a user device for each user, one or more access points with which each user device may communicate, and a central computing system that may control and facilitate communication within the communication system. The central computing system and the access points may be connected together by a computer/communications network, such as a local area network (LAN), a wide area network (WAN), or another other similar network.

As noted above, the user device could be a portable wireless device that supports hands-free, voice communications. The user device could include one or more microphones that receive voice commands and other voice input from a user, and one or more speakers that generate audible output signals. Further, the user device could include a wireless communication module, enabling the device to connect with the network and engage in communication through the system.

The user device could be sufficiently small and lightweight enough so that the user could comfortably wear the device by clipping the device onto the user's collar or shirt pocket or wearing the device on a lanyard around the user's neck. In an example implementation, hands-free operation of the device using voice commands uttered by the user may also require the device to be situated within no more than a particular distance below the chin of the user so that the device can receive the voice audio (e.g., an utterance) from the user with sufficient volume and at an expected angle of arrival, to facilitate recognition and processing of the voice by the device and/or the central computing system.

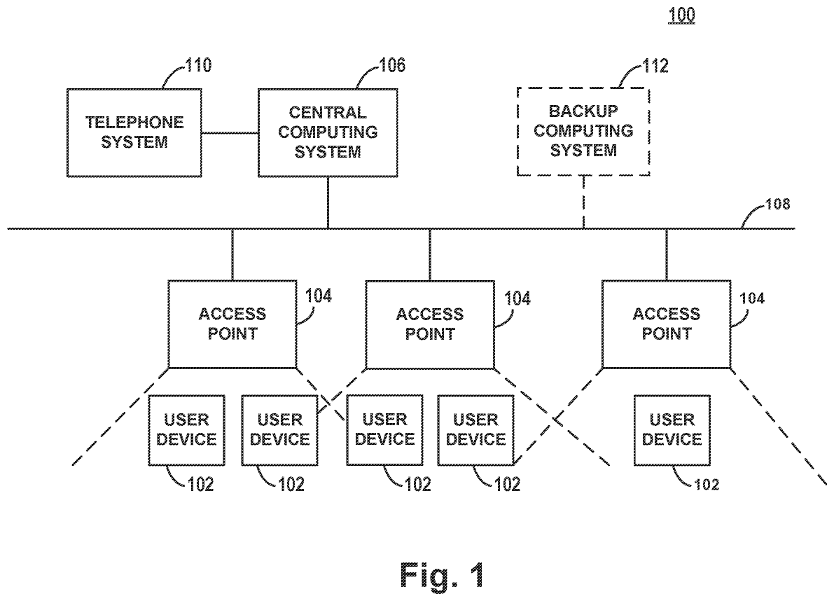

FIG. 1 is a simplified illustration of example communication system 100 that could enable communication between users each equipped with the representative user device, and between those users and supporting systems. As illustrated, the example communication system includes multiple user devices 102, multiple wireless access points 104, and a central computing system 106, such as a server computer or cluster of computers. Further, as shown, the central computing system 106 and access points 104 could be connected with each other over a communication network 108, such as a LAN and/or WAN, to facilitate communication between the user devices 102 and the computing system 106. In addition, as shown, the computing system may be connected to a telephone system 110, such as the private branch exchange (PBX) system and voicemail system, to facilitate connecting outside calls. And the communication system 100 could further include a backup computing system 112 (shown in phantom), also with the computer network 108.

In an example implementation, the access points 104 could be located in a workplace or other facility (e.g., building), such as within healthcare facilities for instance, or could be distributed among multiple such facilities. For instance, for a large work environment encompassing multiple facilities, network 108 might comprise multiple LANs interconnected through the Internet or other WAN, with access points 104 distributed throughout each LAN. In that implementation, the central computing system 106 could also be distributed throughout the various facilities, and/or a central system could control communications within and between all of the facilities. Other arrangements could be possible as well.

The access points 104 of the wireless commination system 100 may be wireless access points that use standard wireless protocols, likely IEEE 802.11 standards supporting WiFi communication, but also possibly other protocols such as BLUETOOTH, ZIGBEE, or the like. In other embodiments, the access points could comprise cellular base stations operating according to a cellular wireless protocol, such as Long Term Evolution (LTE) or 5G New Radio (5G NR), among other possibilities. In any case, the wireless communication module of each user device 102 could be configured to support corresponding communication. For instance, if the access points 104 support WiFi communication according to 802.11 standards, each user device's wireless communication module could correspondingly support WiFi communication and service by the access points 104.

Each access point 104 could provide a respective coverage area within which to serve user devices 102. The range of this coverage area could depend on various factors, such as antenna configuration, power settings, and wireless communication protocol for instance. Further, to permit handoff of user devices between the access points 104, the access points 104 could be positioned and configured so that their coverage areas overlap with each other as shown in the figure. When a user device initially powers on or otherwise enters into coverage of this system, the user device may scan for coverage of an access point. And upon detecting coverage of an access point with sufficient signal strength, the user device may then engage in signaling to connect with the access point. Once connected with the access point, the user device may then engage in communication through the network 108 with the central computing system 106 and ultimately with other user devices and/or with supporting systems.

In an example implementation, the central computing system 106 could be responsible for the overall control and operation of the communication system 100. To facilitate this, the central computing system 106 could include a network communication interface (e.g., Ethernet interface) for communicating on network 108, and could further include one or more processing units (e.g., one or more general purpose processors such as microprocessors, and/or one or more specialized processors such as digital signal processors or application specific integrated circuits), non-transitory data storage (e.g., one or more volatile and/or non-volatile storage components such as read-only memory (ROM), random access memory (RAM), electrically erasable programmable read only memory (EEPROM), flash memory, optical storage, magnetic storage, or the like), and program instructions stored in the data storage and executable by the processing unit(s) to carry out various computing system operations. Without limitation, for instance, the computing system 106 could be programmed with software application programs running on an operating system such as a Windows or Linux based operating system.

Among other operations, the central computing system 106 could maintain records of profile and presence state of the user devices 102 that are configured to operate in the communication system 100. For instance, the computing system 106 could maintain profile records that assign particular users to particular user devices 102 and that include other associated information such as user name, job title, department, and contact lists, as well as voice signatures or the like. Further, the computing system 106 could maintain presence or registration records, indicating for each device whether and when the device is present and connected within the communication system and perhaps which access point is currently serving the device.

Once a user device 102 connects with an access point in the communication system 100, the user device 102 may then engage in registration signaling with the computing system 106 to register its presence in the communication system 100, and the computing system 106 may update a presence record for the user and the user device 102 accordingly. Further, while so connected, the user device 102 may also send periodic heartbeat messages to the computing system 106 to inform the computing system 106 that the user device 102 remains actively connected. And when the computing system 106 stops receiving those heartbeat messages from a user device 102 or otherwise learns that the user device 102 is no longer actively connected in the communication system 100, the computing system 106 may update the user's and device's presence record to indicate that the user device 102 is no longer actively connected.

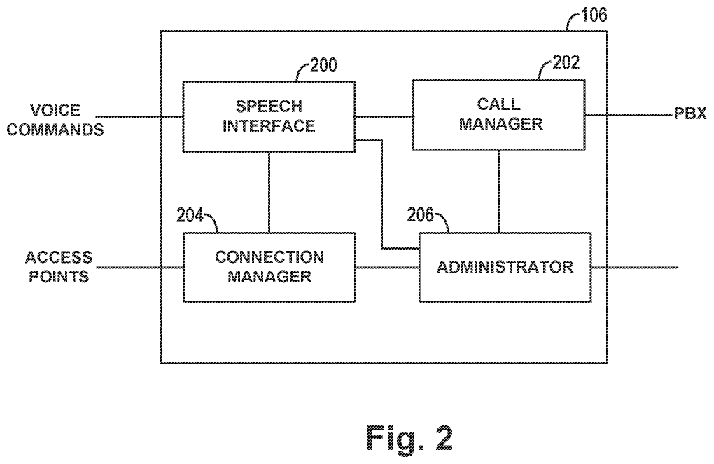

FIG. 2 is a simplified block diagram depicting example application programs that could be included in the computing system 106. As shown in FIG. 2, the example application programs include a speech interface 200, a call manager 202, a connection manager 204, and an administrator 206. In an example implementation, the speech interface 200 could include a conventional software-based engine that supports text-to-speech and speech-to-text conversion, enabling the computing system to receive, interpret, and execute voice commands from the user devices 102 and to provide voice-based messaging to the user devices 102 for presentation. The call manager 202 could include a conference bridge system that supports setting up and connecting calls between the user devices 102 and perhaps with an external telephone network, and may support two-party and multi-party calls. The connection manager 204 may function to maintain presence and registration information regarding user devices 102 as noted above. And the administrator 206 may provide a web-based interface to facilitate configuring and monitoring of the communication system 100. Other arrangements could be possible as well.

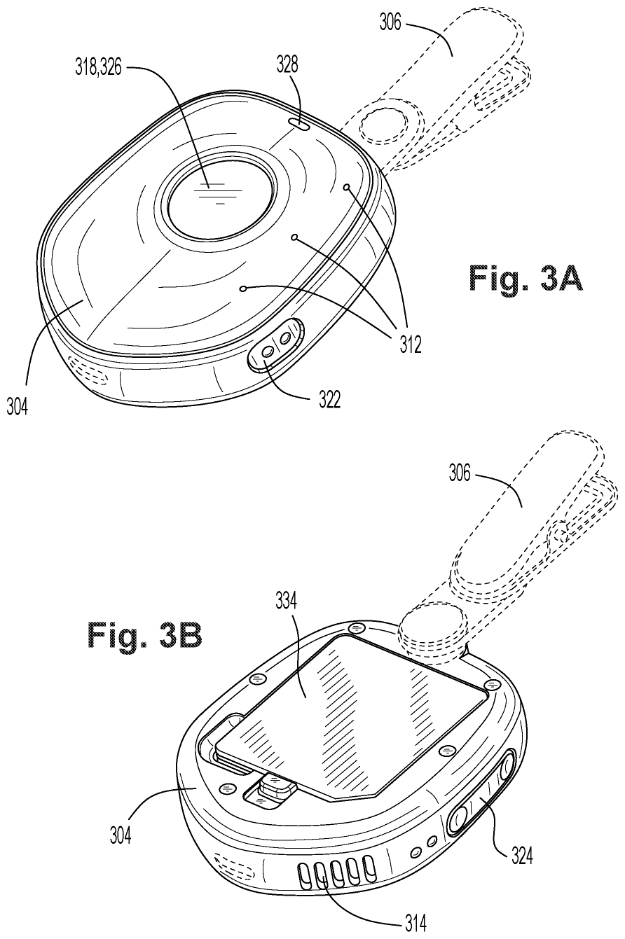

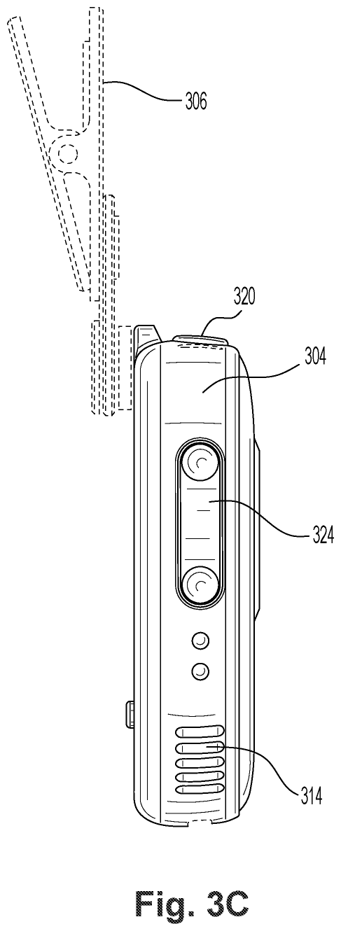

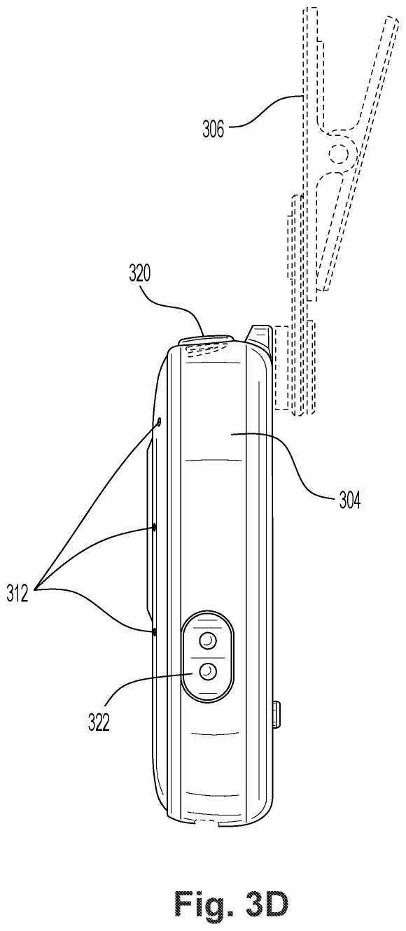

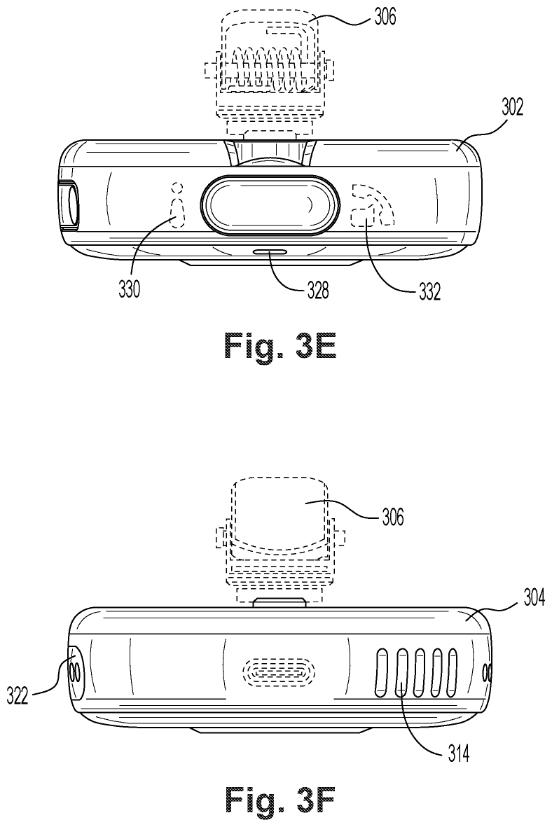

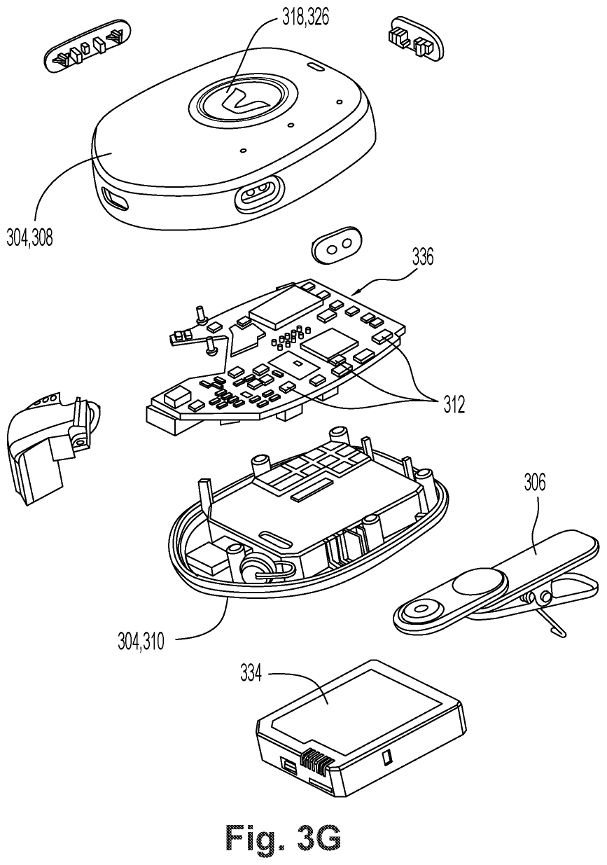

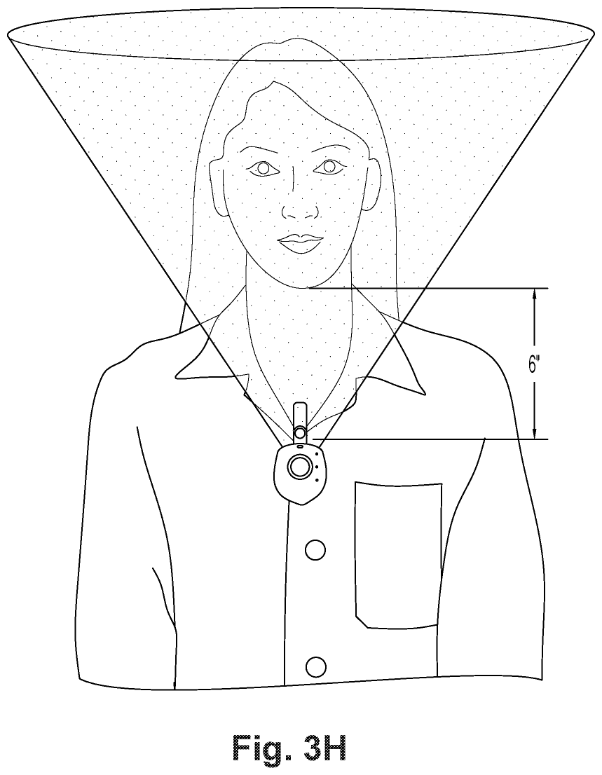

As noted above, the user device 102 could be a lightweight, portable, battery powered device, configured to support voice-based communication and wireless network communication. Such a device could take various forms. Without limitation, FIGS. 3A-3G depict a representative example device as user device 302.

As shown in FIGS. 3A-3G, the example user device 302 includes a device housing 304, with an associated clip assembly 306 that enables clipping of the device onto a user's collar, shirt pocket, or the like, or onto a lanyard worn around the user's neck.

As shown in the exploded view of FIG. 3G, the housing 304 of the device 302 could be formed from multiple pieces that are joined together. For example, the housing 304 could have a front cover 308 and a back cover 310. In other embodiments, the housing 304 may be formed as a single piece construction. The housing 304 could be constructed using a variety of manufacturing processes, such as, for example, injection molding and/or vacuum forming. In addition, the housing 304 could be formed from a number of materials, including, but not limited to, thermoplastic polyurethane (TPU), plastic, metal, rubber, and/or a combination of these and/or other materials.

As shown in FIGS. 3A, 3D, and 3G, the device 302 includes a linear microphone array 312, which is shown accessible through holes in a front surface of the housing 304 but could alternatively be arranged to be accessible through holes at a side surface or elsewhere on the device 304. The linear array 312 could include three linearly aligned microphones as shown, or could alternatively include a different number of linearly aligned microphones, optimally at least two microphones that are vertically spaced from each other by a distance on the order of 2 to 5 centimeters or so. (In an alternative implementation, the microphones could be horizontally offset from each other rather than being directly in line with each other, but would still be vertically spaced from each other.) The microphones of the linear array 312 could be digital microphones configured to receive acoustic input and to convert the acoustic input into a stream of digital samples for processing by the device 302.

In addition, as shown in FIGS. 3B, 3C, and 3F, the device 302 includes a speaker 314, which is shown accessible through holes at a bottom side surface of the housing 304 but could alternatively be disposed elsewhere on the housing 304, optimally far enough away from the microphones 312 to help prevent feedback or other issues. The speaker 314 is configured to output voice, tones, and/or other audio to be heard by the user.

As additionally shown in FIGS. 3A-3G, the device 302 includes a number of user-accessible buttons, such as an activation button 318, a do-not-disturb/hold button 320, a panic button 322, and volume-control buttons 324.

The activation button 318 may be a primary control for user interaction with the device 302, as an alternative or in addition to voice control of the device 302. Further, the activation button 318 could invoke various different device functions depending on context. For instance, depending on context, the user may engage the activation button 318 to initiate a dialog with a system agent (the “Genie”) or may engage the activation button 318 to accept an incoming call or to initiate other call-related functions. In addition, the device 302 may respond differently to engaging on the activation button depending on whether the user presses and immediately releases the button or the user presses, momentarily holds, and then releases the button.

The do-not-disturb/hold button 320 may also be a momentary push button, or may be a toggle switch, specifically for placing the user device 302 in a do-not-disturb (DND) mode if no call is currently in progress or in a hold mold if a call is in progress. As shown, the DND/hold button 320 could be disposed at the top of the device 302, for convenient access. Further, the DND/hold button 302 may be backlit by a multi-color LED that is normally inactive but that turns on when the device 302 is in the DND mode or hold mode, possibly lighting differently depending on which of these modes is on—such as blinking while the device 302 is in the DND mode or being continuously illuminated while the device 302 is in the hold mode.

The panic button 322 may likewise be a momentary push button, situated near or at the top of the device 302 for convenient access. When the user engages the panic button 322, the device 302 may send a panic message, which may cause the central computing system 106 to send notifications to other users, indicating an emergency or urgent matter. Further, the adjustment control buttons 324 may have a push-button configuration and be situated along a side of device 302 as shown, enabling the user to change volume of audio output (e.g., speaker) of the user device 302.

In addition to the LED indicators of the DND/hold button, the device 302 may include a number of other surface-facing LED indicators, some of which are shown in FIGS. 3A, 3E, and 3G. These indicators include a status indicator 326, a connectivity indicator 328, an alert indicator 330, and a message indicator 332. Further, the device may also include an internal haptic device configured to produce haptic vibration to indicate various alerts, status, or other information.

The status indicator 326 is integrated with the activation button 318 and could output various different colors to indicate various different operations states of the device 302. For instance, the status indicator 326 may slowly blink a green light to indicate that the device 302 is within wireless coverage of the communication system 100, the status indicator may slowly blink a red light to indicate that the device 302 is not within coverage of the system 100. Further, other blinking patterns and light colors could be used to indicate other conditions, such as that battery level of the device is threshold low for instance. The status indicator 326 and activation button 318 may also cooperatively display a logo, design, or other pattern, such as a company logo, as shown in FIG. 3G for instance.

The connectivity indicator 328 could indicate whether the device 302 is connected with the communication system 100, such as whether the device has established WiFi connectivity with an access point 104 for instance. Like the status indicator 326, the connectivity indicator 328 may present various different colors and/or blinking patterns to indicate various different states. For instance, the connectivity indicator 328 could present a solid green light to indicate when the user device is connected with the system 100 and could present a white or yellow light to indicate when the user device is not connected with the system 100.

The alert indicator 330 could function to present an alert to the user of the device 302 and may present different colors to indicate various different alerts. Further, the message indicator 332 could function to notify the user that a message has been received for the user, e.g., that the computing system 106 has received a message that is waiting to be delivered to the user. The message indicator 332 may present various different colors and/or blinking patterns to indicate various different message states. For instance, the message indicator could present a fast blinking green light to indicate that a message is waiting for the user.

To facilitate portable use, the device 302 further includes a rechargeable battery 334 to power various components of the device 302. As shown in FIGS. 3B and 3G, the battery 334 could be configured to fit within a battery receptacle at the back of the device 302 in order to establish electrical communication with and supply power to various device components. Further, the battery 334 could be removable by a user to facilitate recharging or replacing the battery. Alternatively, the battery 334 could be permanently housed within the device 302, possibly not removable by the user, and the device 302 could include a wired, inductive, or other mechanism to recharge the battery 334. The battery could be of various types, such as nickel metal hydride (NiMH), nickel cadmium (NiCd), Lithium Ion (Li-Ion), or lithium polymer (Li-Poly), among other possibilities. Further, the device 302 could alternatively use more than one battery and/or another power source.

Because the example device 302 may be largely voice controlled, the device 302 might not include any display screen. Alternatively, the device may include one or more display screens.

In use, to enable the device 302 to receive and process voice commands spoken by the user and to receive other voice audio spoken by the user, it may be best to situate the device 302 about 6 inches below the chin of the user, as shown in FIG. 3H. Further, with the linear microphone array 312 oriented as shown the figures, it may be best to orient the device 302 itself vertically when worn by the user (i.e., with the top of the device 302 facing straight up) so that the linear microphone array of the device 302 will also be oriented vertically. This vertical orientation of the microphone array could help facilitate the device's evaluation of separate microphone audio channels as a basis to determine whether received voice audio is spoken by the user wearing the device or rather by another user. To so orient the device, the clip assembly 306 could be configured with one or more pivot points that enable the device to rotate at its juncture with the clip assembly and hang downward in the desired vertical orientation if possible. In an alternative implementation, a user may carry the user device 302 in a pocket or holster, and the user may then remove the device 302 and bring it into the optimal position to support providing voice commands and other voice audio.

As shown in the exploded view of FIG. 3G, the example user 302 device contains a printed circuit board (PCB) 336. This PCB is configured with numerous components to facilitate operation of the device 302.

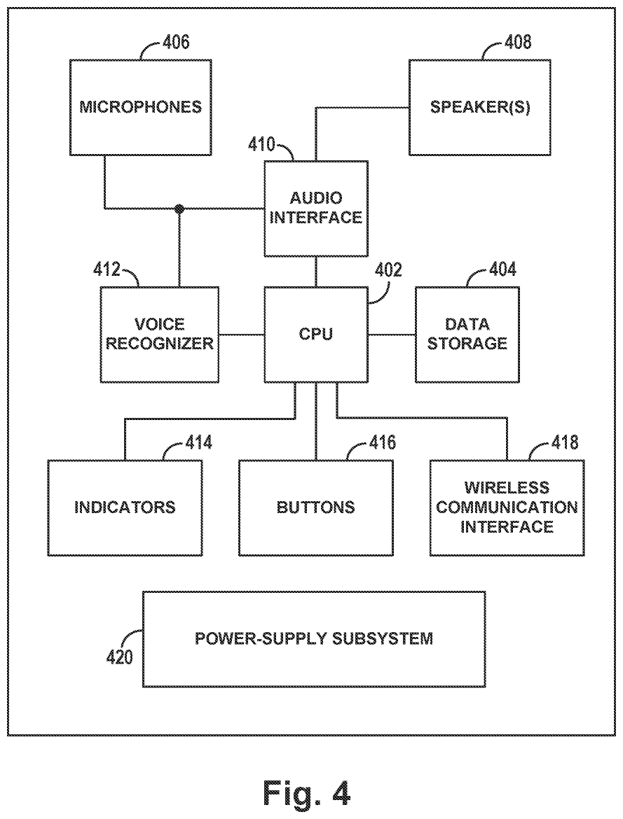

Without limitation, FIG. 4 is next a simplified block diagram illustrating hardware components of the device 302 in an example implementation. As shown in FIG. 4, the device includes a central processing unit (CPU) 402, non-transitory data storage 404, microphones 406, speaker(s) 408, an audio interface 410, a voice recognizer 412, indicators 414, buttons 416, a wireless communication interface 418, and a power-supply subsystem 420. In the example implementation, many of these components could be mounted on the PCB 400.

The CPU 402 functions as a host processor of the device 302, configured generally to control operation of the device 302. CPU 402 could be a processor with an ARM core running a Linux operating system, among other possibilities and could be mounted on the PCB 336 in electrical, optical, or other communication with various device components as shown, through various pins of the CPU 402.

The CPU 402 could have at least a full-power state and a low-power sleep state and could selectively operate in either of these states. In the full-power state, the CPU 402 could be fully operational, with its CPU clock and system clock running and the CPU executing various applications and performing various computations, consuming a level of battery energy to perform its operations. Whereas, in the sleep state, the CPU clock and various other CPU operations may be halted, so the CPU 402 could consume far less battery energy. Power state of the CPU 402 could operate in accordance with a state machine, which could involve transitioning the CPU 402 from the full-power state to the sleep state in response to various triggers (e.g., after a period of inactivity, or upon learning that the device 302 has left coverage of the system 100) and transitioning the CPU 402 from the sleep state to the full-power state in response to various triggers (e.g., periodically to send heartbeat messages or to scan for WiFi coverage, or upon receipt of an interrupt signal such as when the device 302 detects wake-word utterance), among other possibilities.

The non-transitory data storage 404, which could likewise be mounted on the PCB 336, could comprise one or more volatile and/or non-volatile storage components such as ROM, RAM, EEPROM, flash memory, or optical storage, among other possibilities. For instance, the data storage 404 could include DDR3L memory and/or flash memory. While the data storage 404 is shown separate from the CPU 402, the data storage could alternatively be integrated in whole or in part with the CPU 402. The non-transitory data storage 404 could hold program instructions (e.g., compiled or non-compiled program logic and/or machine code) executable by the CPU 402 to carry out or cause the device 302 to carry out various device processing operations discussed herein. Further, the non-transitory data storage 404 could hold reference data for access by the CPU 402 to facilitate carrying out some of those operations.

The microphones 406, which could also be mounted on the PCB 336, could define the linear microphone array 312 noted above. As indicated above, the microphones 406 could be digital microphones configured to receive acoustic input defining an audio waveform and provide digital output in the form of a sequence of digital samples of the received audio waveform, in a pulse density modulation (PDM) or pulse code modulation (PCM) format for instance, for processing by the CPU 402 and/or the voice recognizer 412. Like the CPU 402, the microphones 406 could have a full-power state and a low-power state and, through CPU control, could selectively operate in and transition between these states. When the CPU 402 transitions to its sleep state, the CPU 402 may also cause one or more of the microphones 406 to enter their sleep state but may keep at least two of the microphones in their full-power state to facilitate their receipt of audio that may represent the wake word.

The speaker(s) 408, which could also be mounted on the PCB 336, could comprise a low profile micro speaker outputting acoustic audio. And the audio interface 410, which could also be mounted on the PCB 336, could be a high-performance, low power audio codec, which could perform analog-to-digital and digital-to-analog conversion among other operations. Digital audio output from the CPU 402 could pass to the audio interface 410, the audio interface could convert that audio to an analog audio waveform, and the speaker(s) 408 could output the audio to be heard by a user. The device 302 may also include an amplifier (not shown) to amplify the audio for output. In addition, the example device 302 may also include a port for connecting a headset and/or may support a wireless headset connection, to facilitate private listening.

The voice recognizer 412, which could also be mounted on the PCB 336, could be a dedicated speech-recognition chipset that operates with low power consumption and could be configured to recognize utterance of particular wake words and other key words. The voice recognizer could run deep-learning algorithms to efficiently detect utterance of a defined wake word, such as “OK Vocera” for instance and could respond to detecting utterance the wake word by signaling to the CPU 402 to trigger further processing.

The indicators 414, which could likewise be mounted on the PCB 336, could comprise the LED indicators noted above, such as the status indicator 326, the connectivity indicator 328, the alert indicator 330, and the message indicator 332. And the buttons 416, which could have communication interfaces with the CPU 402, could comprise the buttons noted above, such as the activation button 318, the DND/hold button 320, the panic button 322, and the volume-control buttons 324.

The wireless communication interface 418, which may also be mounted on the PCB 336, could comprise one or more wireless interfaces configured to enable short-range communication with one or more networks according to one or more wireless local area network (WWAN) protocols such as IEEE 802.11, BLUETOOTH, or ZIGBEE protocols for instance. Further, the wireless communication interface 418 may also include one or more interfaces to enable long-range (e.g., cellular) communication according to one or more wireless wide area network (WWAN) protocols such as LTE or 5G NR for instance. The wireless communication interface 418 could comprise one or more transceivers with transmit and receive chains, as well as one or more antennas to facilitate air-interface communication with access points, base stations, or the like. In some implementations, the antenna(s) of could be integrated with the housing 304, clip assembly 306, or other component. Alternatively, the antenna(s) could reside completely within the device 302.

Like the CPU 402 and one or more other components of the device 302, the wireless communication interface 418 could have a full-power state and a low-power sleep state and could selectively operate in either of these or other states, under control of the CPU 402 for instance.

Upon transitioning to full-power state, the wireless communication interface 418 (e.g., WiFi module) could scan for coverage of an access point 104 having a predefined service set identifier (SSID), and upon finding such coverage with sufficient signal strength, the wireless communication interface 418 could engage in signaling with the access point 104, to establish a connection between the wireless communication interface 418 and the access point 104, and thus between the device 302 and the access point 104. Upon establishing this connection, the wireless communication interface 418 could then signal to the CPU 402 to inform the CPU 402 that the device is now connected, and the CPU 402 could then take further action, such as to engage in communication over that connection and network 108 with central computing system 106 for instance.

While so connected with an access point 104, the wireless communication interface 418 could further regularly monitor its coverage strength. This monitoring could facilitate triggering handoff of the wireless communication interface 418 between access points as the device 302 moves from one access point's coverage to another access point's coverage. Further, this monitoring could enable the wireless communication interface 418 to detect when it loses wireless coverage (e.g., when a user takes the device 302 out of range of the communication system 10). Upon losing wireless coverage, the wireless communication interface 418 could then transition to the sleep state and could wake up periodically, possibly under CPU control, to newly scan for wireless coverage. Further, while within wireless coverage, the wireless communication interface 418 may from time to time transition from its full-power state to its sleep state. And when in the sleep state while within wireless coverage, the wireless communication interface may wake up periodically to check for any unicast and/or multicast messages being wirelessly transmitted to the device 302 and may then transition back to the sleep state absent receipt of such a message.

The power-supply subsystem 420 could then include the battery 334 noted above, configured to supply power to the CPU 402 and other components of the device 302. Further, the power-supply subsystem 420 could include a battery-level gauge (e.g., a voltmeter or coulomb counter), possibly integrated with the battery 334, configured to monitor, report, and manage battery charge level, which could support lighting of a battery-level indicator when appropriate.

To facilitate use of the example user device 302 in practice, a healthcare organization (e.g., hospital) or other organization could equip its facilities with a communication system 100 like that shown in FIG. 1 and could equip each of its workers (e.g., professionals, support staff, and others) with a respective instance of the user device 302. Further, an administrator of the organization could register each such user and user device 302 with the system, through a web-based interface with computing system 106 for instance.

An administrator or user could power on the user device 302 by simply inserting the battery 334 into the device 302, without a need to press a power button, as the device 302 may operate in an always-on state from the user's perspective even though components of the device 302 may transition operate in a sleep state from time to time. So powering on the device 302 could in turn trigger the device scanning for and acquiring wireless connectivity if possible, and engaging in other device operations.

When a user receives an instance of the device 302, perhaps at the time of initial battery insertion, the device 302 may prompt the user to identify himself or herself verbally. Further, the user may need to speak a password provided by the administrator, or the computing system 106 may evaluate a voice signature of the user to confirm that the user is an authorized user. Once the user has identified himself or herself, and upon possible authentication, the computing system 106 may then establish a record associating the user with the instance of the user device 302, so that the system 106 could then interact with the user by interacting with that instance of the device 302 (e.g., to facilitate routing calls, messages, and alerts to the user). Once the user is assigned to a given device 302, the device 302 may also output a verbal welcome greeting personalized to the user (e.g., “Hello, John”).

In an example implementation, a particular user device 302 may be assigned to at most one user at a time, and each user may be assigned to just one device 302 at a time. Though a given user device 302 may be reassigned to a different user at another time.

After a user device 302 is assigned to a user, the device 302 may enter the low-power sleep state. In that state, as noted above, the user could utter the predefined wake word to wake up the device, in response to which the device could then transition to a full-power state in order to engage in various device operations.

When the device 302 is operating in full-power state, as the user then utters voice commands or provides other voice audio, the device could transmit that audio through network 108 to the computing system 106 for analysis and processing and/or the device itself may analyze and process some such voice audio. Likewise, the device could receive voice audio and other audio from the computing system 106 and could output that audio audibly for hearing by the user. Further, the device could engage in various other signaling with the computing system 106.

For instance, if the user wishes to call another user named “Bob Smith”, the user may initiate that communication by speaking the voice command “Call Bob Smith”. As the device 302 receives this voice audio, the device 302 may then pass the audio in digital form to the central computing system 106, and a speech recognition engine at the computing system 106 may interpret the command, learning that the user wishes to call user Bob Smith. And in response, the computing system 106 may then engage in signaling with Bob Smith's user device 302 and may bridge the user with Bob Smith so that they can engage in the call. In one implementation, voice call audio could then flow between the user and Bob Smith through the central computing system 106. In an alternative implementation, the central computing system 106 could operate as a third party call controller, to set up the voice call more directly between the two parties.

As noted above, the present disclosure provides various technical mechanisms to help address the technical problems discussed above. In particular, the disclosure provides a mechanism for improved power management in a battery-powered wireless communication device, and the disclosure also provides a mechanism for improved wake-word detection in a wearable electronic device.

As to power management, as discussed above, a technical issue relates to how often the device 302 should scan for wireless coverage once the device has left wireless coverage. In an arrangement like that discussed above, this issue could arise if a user who is equipped with the example user device 302 leaves wireless coverage of communication system 100 altogether, such as by moving out of the coverage that is cooperatively provided by the access points 104 of the system 100. When the device 302 leaves that wireless coverage, its wireless communication interface 418 may detect the absence of that wireless coverage and may, possibly after a hysteresis period to help ensure actual loss of connection, responsively signal to the CPU 402 to inform the CPU 402 that the device is no longer wirelessly connected.

In one implementation of the device 302, the CPU 402 may respond to this indicated loss of connection by transitioning the device 302 from its current power state to a sleep state. Among possibly other operations, this transitioning of the device to the sleep state could involve the CPU 402 signaling to various components of the device to direct and thus cause them to transition to low-power sleep states of their own and the CPU 402 then also transitioning to a sleep state of its own.

At least one device component that the CPU 402 thereby puts in the sleep state could be the wireless communication interface 418. Transitioning the wireless communication interface 418 to the sleep state could involve the wireless communication 418 interface tuning off its transceiver, so that the wireless communication interface 418 stops transmitting and receiving radio frequency electromagnetic energy, thus helping to conserve power of the device 302. Further, transitioning the wireless communication interface 418 to the sleep state could involve the wireless communication interface 418 powering down and/or discontinuing other aspects of its operation as well or instead, which could also help to conserve power.

In this implementation, once the CPU 402 has put at least the wireless communication interface 418 in the sleep state, the CPU 402 could also put itself into the sleep state. Transitioning the CPU 402 to the sleep state could involve the CPU 402 powering down various aspects of its own operation as noted above, such as halting its CPU clock and various computations, which could also help to conserve battery power. In the sleep state, however, the CPU 402 may still retain some rudimentary operation, such as running a real-time internal counter and also monitoring for receipt of interrupt signaling from other device components that may be seeking to communicate with the CPU 402 (e.g., in response to user pressing of a button or uttering the wake word).

Turning now to wakeup-word detection, as noted above, a technical issue relates to how the device 302 could detect when its user utters a wake word (e.g., word or phrase) when the device 302 is in a low-power sleep state, in response to which the device may then transition back to its full power state. Further, as noted above, subsidiary or additional include (i) how to efficiently control power of the device in relation to detecting and responding to the wake word when the device is in the low-power state and (ii) how to ensure that the wake word is uttered by the user of the device rather than by another nearby user, i.e., to avoid waking up the device in response to another nearby user uttering the wake word.

As noted above, a technical solution to these issues could involve implementing a dual-stage wake-work detection process and making use of a linear microphone array to help determine whether the wake word is uttered by the user of the device or rather by another nearby user. Further, even without the dual-stage wake-word detection process, the using the linear microphone array to help determine whether the wake word is uttered by the user of the device could be beneficial.

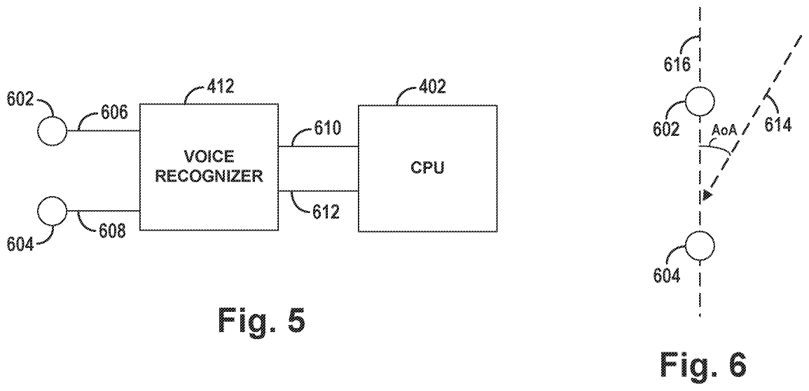

FIG. 5 is a simplified block diagram that helps to illustrate how this could work in practice. In particular, FIG. 5 illustrates two example microphones 602, 604 of the linear array 312 of device 302, with respective digital audio feeds 606, 608 from the microphones passing to the voice recognizer 412, and with a serial line (e.g., Serial Peripheral Interface (SPI) or other serial interface) 610 and an interrupt line 612 passing in turn from the voice recognizer 412 to the CPU 402.

With this arrangement, when the device 302 is in a sleep state, with CPU 402 in a sleep state, the microphones 602, 604 and the voice recognizer 412 may remain operating in their low-power mode, with the microphones 602, 604 feeding any received audio to the voice recognizer 412 for processing. When the microphones receive an acoustic audio waveform that represents utterance of the wake word (e.g., “OK Vocera”), the voice recognizer may thereby recognize utterance of that wake word, by analyzing the audio from one or more of the microphones.

At that point, the device 302 would have detected utterance of the wake word. However, the device may not yet know if that wake-word utterance was from the user of the device 302 or was rather from another, unintended user. To facilitate having the device 302 address this question, the voice recognizer 412 could respond to detecting utterance of the wake word by (i) sending an interrupt signal to the CPU 402 to wake up the CPU 402 and (ii) passing to the CPU 402 the received audio for processing by the CPU 402. And the CPU 402 could then process that audio to make a determination of whether or not audio came from the user of the device 302.

In an example implementation, the digital audio feeds from the microphones 602, 604 to the voice recognizer 412 could be separate digital audio channels, one from each microphone, and the audio feed that the voice recognizer 412 then passes to the CPU 402 after detecting utterance of the wake word could be a serialized stream, interleaving those two digital audio channels. As noted above, each of these digital audio channels could comprise a sequence of digital samples representing the respectively received acoustic audio waveform. As such, each digital audio channel could represent both the amplitude and phase of the respective audio waveform.

When or as the CPU 402 receives these audio channels passes along by the voice recognizer, the CPU 402 could engage in processing to determine whether the audio came from the user of the device 302 or rather from another user. As noted above, the CPU 402 could make this determination based on consideration of an angle of arrival (AoA) (i.e., angle of incidence) of the received audio into the microphones of the linear array 312 and/or an energy level of the received audio. Various implementations are possible.

In one implementation, the CPU 402 could determine the AoA of the received audio, which FIG. 6 shows by way of example as being the angle between the direction of arrival 614 of the audio and the plane 616 of the linear microphone array 312, and could use that AoA as a basis to determine whether the audio came from the user of the device 302 or rather from another, unintended user. The CPU 402 could do this by considering the phases of the audio waveforms received respectively by the different microphones of the linear array 312.

Having the microphones 602, 604 be vertically separated from each other (e.g., in a vertically oriented linear array like array 312) when the device 302 is worn by the user at a suitable distance below the user's chin could facilitate this. In particular, with this arrangement, when an audio waveform is provided by the user speaking, the AoA of that audio waveform at the linear array would be fairly acute, and the waveform would arrive at the two vertically spaced microphones at different times, with a phase difference between the audio as received by one microphone and the same audio as received by the other microphone. On the other hand, if an audio waveform is provided by another user speaking, the AoA of that audio waveform at the linear array would be less acute, possibly obtuse.

By comparing the phases of the respective microphones' received audio channels as to the wake-word utterance, the CPU 402 could therefore determine whether the wake word was uttered by the user wearing the device 302 or rather by another, unintended user. In particular, comparing the phases of the two audio channels could establish what the AoA is, and the CPU 402 could compare that established AoA with a configured threshold angle, to make the determination. If the CPU 402 determines that the AoA is smaller than (e.g., less than or equal to) the threshold, then the CPU 402 could conclude that the audio waveform came from above the linear array and thus likely from the wearer of the device 302. Whereas, if the CPU 402 determines that the AoA is larger than the threshold, then the CPU 402 could conclude that the audio waveform did not come from the wearer of the device 302, and perhaps that the audio waveform came from another, unintended user.

If the CPU 402 determines through this process that the wake-word audio was uttered by the user of the device (e.g., that the determined AoA is sufficiently small), then the CPU 402 could respond to that determination by proceeding to wake up the device 302. For instance, the CPU 402 could send signals to various components of the device that are in sleep mode to direct and thus cause them to wake up, thereby allowing full operation of the device 302. On the other hand, if the CPU 402 determines through this process that the wake-word audio was not uttered by the user of the device (e.g., that the determined AoA is too large), then the CPU 402 could respond to that determination by discarding the utterance and going back to sleep.

As a variation of this implementation, the CPU 402 could conduct this analysis on time segments of the utterance and could then compute and evaluate an average or other rolled-up representation of AoA across the multiple time segments. For instance, the CPU 402 may break the received audio into segments of 1 millisecond (ms), 5 ms, 10 ms, or 20 ms each and separately determine the AoA for each interval. The CPU 402 could then compute an average of those determined AoAs across the utterance as a whole and could compare that average AoA to the threshold angle to determine as noted above whether the utterance came from the wearer of the device 302 and thus whether to proceed with waking up the device 302 or rather to discard the utterance.

In another implementation, the CPU 402 could determine an energy level of the received audio, perhaps a decibel root mean square (dB RMS) value representing the overall energy level of the audio, and could use that energy level as a basis to determine whether the audio came from the user of the device 302 or rather from another, unintended user. A rationale for this could be that, if the user is wearing the device 302 at a suitable distance from the user's chin as noted above (among other possibilities), the energy level of an audio waveform representing the user's voice would likely be higher than the energy level of an audio waveform representing the voice of a user farther away from the device 302.

In this implementation, the CPU 402 could compare the determined energy level of the received audio (e.g., a combination of the received audio channels, or perhaps just one of the received audio channels) with a configured threshold energy level. And if the CPU 402 determines that the energy level is at least as high as that threshold, then the CPU 402 could conclude that the audio waveform came from the wearing user. Whereas, if the CPU 402 determines that the energy level is smaller than the threshold, then the CPU 402 could conclude that the audio waveform did not come from the wearing user, and perhaps that the audio waveform came from another, unintended user.

If the CPU 402 determines through this process that the wake-word audio was uttered by the user of the device (e.g., that the determined energy level is sufficiently high), then the CPU 402 could respond to that determination by proceeding to wake up the device 302 as noted above for instance. On the other hand, if the CPU 402 determines through this process that the wake-word audio was not uttered by the user of the device (e.g., that the determined energy level is too small), then the CPU 402 could respond to that determination by discarding the utterance and going back to sleep.

As a variation of this implementation as well, the CPU 402 could conduct this analysis on time segments of the utterance and could then compute and evaluate an average or other rolled-up representation of energy level across the multiple time segments. For instance, the CPU 402 may break the received audio into segments as noted above and separately determine the energy level for each interval. The CPU 402 could then compute an average of those determined energy levels across the utterance as a whole and could compare that average energy level to the threshold energy level to determine as noted above whether the utterance came from the wearer of the device 302 and thus whether to proceed with waking up the device 302 or rather to discard the utterance and go back to sleep.

In yet another implementation, the CPU 402 could use a combination of AoA and energy level (among possibly other factors) as a basis to evaluate whether to accept or reject the wake word utterance. This implementation could in turn also take various forms.

As one example, the CPU 402 could require both (i) that the AoA meet an AoA threshold indicating that the utterance is likely from the wearer of the device and (ii) that the energy level meet an energy level threshold indicating that the utterance is likely from the wearer of the device. If the CPU 402 determines that both of these thresholds are met, then the processor could accept the utterance and proceed. Whereas, if the CPU 402 determines that at least one of these thresholds is not met, then the CPU 402 could reject the utterance and go back to sleep.

As another example, as with the variations noted above, the CPU 402 could break the audio into time segments as noted above, and could decide based on AoA per segment whether to retain the digital samples of that segment or rather to zero them out. Namely, for each segment, the CPU 402 could (a) determine the AoA of the segment, (b) compare that determined AoA with the AoA threshold, and (c) based on that comparison, decide whether or not to zero out that interval of audio, namely, (i) if the AoA meets the threshold, then retain the audio samples of that interval, whereas (ii) if the AoA does not meet the threshold, then zero out the audio samples of that interval.

The CPU 402 could then compute a representative energy level, such as an average energy level, across the segments of the utterance, including any zeroed-out segments, so that the computed energy level of the utterance may be lower if and to the extent more segments are zeroed out. And the CPU 402 could compare that representative energy level with the threshold energy level to determine as noted above whether the utterance came from the wearer of the device 302 and thus whether to proceed with waking up the device 302 or rather to discard the utterance and go back to sleep.

With any of these or other implementations, the CPU 402 could also apply noise reduction to the received audio waveform representing the wake-word utterance. This noise reduction may help to effectively narrow or focus the received audio by filtering out some noise. Further, the CPU 402 may also apply noise reduction as to other audio that the CPU 402 receives from the user during normal operation (e.g., when the device 302 is awake and the user utters voice commands or speaks during a communication being carried through system 100). Though the CPU 402 may apply a relatively higher degree of noise reduction for wake-word detection than as to other received audio, to help avoid waking up the device 302 if an uttered wake word does not come from the user of the device 302.

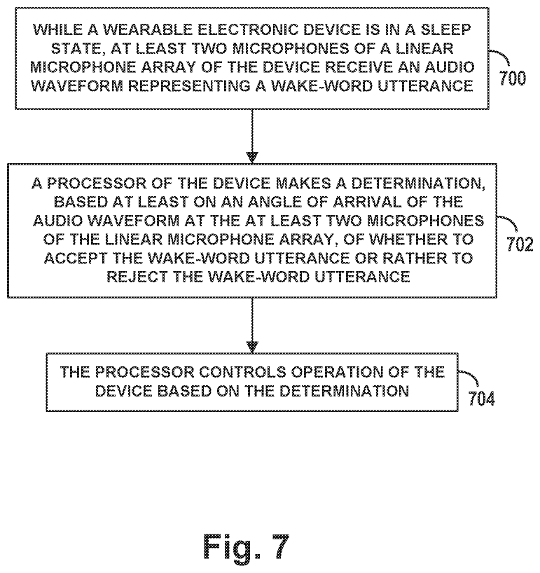

FIG. 7 is a flow chart depicting an example method of wake-word processing that can be carried out by a wearable electronic device when the device is worn by a user (e.g., at a distance of about 5 to 7 inches below a chin of the user) and the device is in a device sleep state, the device including a linear microphone array having at least two microphones vertically spaced from each other, and the device also including a processor (e.g., CPU).

As shown in FIG. 7, at block 700, the example method includes the at least two microphones of the linear microphone array receiving an audio waveform representing a wake-word utterance. At block 702, the method then includes the processor making a determination, based at least on an angle of arrival of the audio waveform at the at least two microphones of the linear microphone array, of whether to accept the wake-word utterance or rather to reject the wake-word utterance. And at block 704, the method includes the processor controlling operation of the device based on the determination.

In line with the discussion above, the act of the processor making the determination of whether to accept or reject the wake-word utterance can be further based on an energy level of the audio waveform received by the at least two microphones. Further, the act of making the determination could be based on a time-segmented evaluation of audio channels from the at least two microphones. And the act of making the determination could represent a determination of whether the wake-word utterance came from the user wearing the device or rather from another, unintended user.

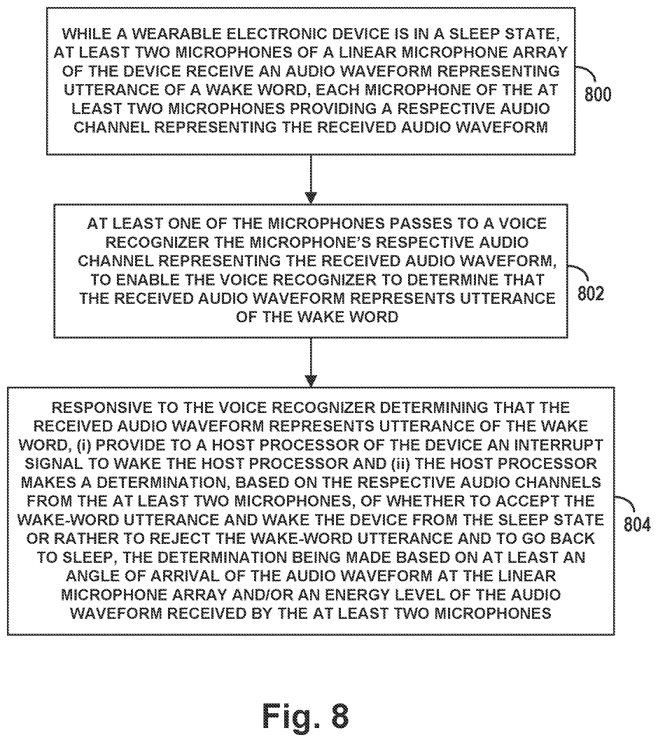

FIG. 8 is next a flow chart depicting an example method of wake-word processing that can be carried out a wearable electronic device when the device is worn by a user (e.g., at a distance of about 5 to 7 inches below a chin of the user) and the device is in a device sleep state, the device including a linear microphone array having at least two microphones vertically spaced from each other, the device including a voice recognizer and a host processor, and the host processor being in a host-processor sleep state.

As shown in FIG. 8, at block 800, the example method includes the at least two microphones of the linear microphone array receiving an audio waveform representing utterance of a wake word, each microphone of the at least two microphones providing a respective audio channel representing the received audio waveform. Further, at block 802, the method includes at least one of the microphones passing to the voice recognizer the microphone's respective audio channel representing the received audio waveform, to enable the voice recognizer to determine that the received audio waveform represents utterance of the wake word.

At block 804, the method then includes, responsive to the voice recognizer determining that the received audio waveform represents utterance of the wake word, (i) providing to the host processor an interrupt signal to wake the host processor from the host-processor sleep state and (ii) the host processor making a determination, based on the respective audio channels from the at least two microphones, of whether to accept the wake-word utterance and wake the device from the device sleep state or rather to reject the wake-word utterance and to go back to sleep. And as discussed above, the host processor could make this determination based on at least (i) an angle of arrival of the audio waveform at the linear microphone array and/or (ii) an energy level of the audio waveform received by the at least two microphones.

In an example implementation, the linear microphone array may have three microphones linearly aligned and vertically spaced from each other including a top microphone, a middle microphone, and a bottom microphone, and the at least two microphones could be just a top microphone and the bottom microphone. In addition, as discussed above, the voice recognizer could pass the respective audio channels of the at least two microphones to the host processor to facilitate the host processor making the determination of whether to accept or rather reject the wake-word utterance.

Further, in an example implementation, the host processor could make the determination based at least on the angle of arrival of the audio waveform at the linear microphone array, which could involve making the determination based on a comparison of the angle of arrival with a predefined angle-of-arrival threshold. And the method could additionally include the host processor controlling, based on the determination, whether (i) to accept the wake-word utterance and wake the device from the device sleep state or rather (ii) to reject the wake-word utterance and to go back to sleep. For instance, if the comparison shows that the angle of arrival is less than the predefined angle-of-arrival threshold, then the host processor could accept the wake-word utterance and wake the device from the device sleep state. Whereas, if the comparison shows that the angle of arrival is greater than the predefined angle-of-arrival threshold, then the host processor could reject the wake-word utterance and going by the host processor back to sleep.

Alternatively or additionally, as discussed above, the host processor could make the determination based at least on the energy level of the audio waveform received by the at least two microphones, which could involve making the determination based on a comparison of the energy level with a predefined energy-level threshold. And the method could likewise involve the host processor controlling, based on the determination, whether (i) to accept the wake-word utterance and wake the device from the device sleep state or rather (ii) to reject the wake-word utterance and to go back to sleep. For instance, if the comparison shows that the energy level is greater than the predefined energy-level threshold, then the host processor could accept the wake-word utterance and wake the device from the device sleep state. Whereas, if the comparison shows that the energy level is less than the predefined energy-level threshold, then the host processor could reject the wake-word utterance and going by the host processor back to sleep.

Further, in these or other implementations, as discussed above, the host processor could make the determination based on a time-segmented evaluation of the respective audio channels.

The present disclosure also contemplates a wearable electronic device being configured to carry out this or other methods. In line with the discussion above, for instance, such a device could include a battery, a linear microphone array having at least two microphones, a processor (e.g., host processor), non-transitory data storage, and program instructions stored in the non-transitory data storage and executable by the processor to carry out the operations of the method (e.g., when the device is worn by a user and is in the sleep state). Further, the disclosure also contemplates a non-transitory computer-readable medium having stored thereon (e.g., being encoded with or otherwise embodying) program instructions executable by a processor to cause a wearable electronic device to carry out such operations when the device is in a sleep state.

Exemplary embodiments have been described above. Those skilled in the art will understand, however, that changes and modifications may be made to these embodiments without departing from the true scope and spirit.

What is claimed is:

1. A method of wake-word processing by a wearable electronic device, the method being carried out when the device is worn by a user and the device is in a device sleep state, wherein the device includes a linear microphone array having at least two microphones vertically spaced from each other, and wherein the device further includes processor, the method comprising:
receiving, by the at least two microphones of the linear microphone array, an audio waveform representing a wake-word utterance;
making a determination, by the processor, based at least on an angle of arrival of the audio waveform at the at least two microphones of the linear microphone array, of whether to accept the wake-word utterance or rather to reject the wake-word utterance; and
controlling, by the processor, operation of the device based on the determination.

2. The method of claim 1, wherein the device is worn by the user at a distance of about 5 to 7 inches below a chin of the user.

3. The method of claim 1, wherein making the determination by the processor of whether to accept or reject the wake-word utterance is further based on an energy level of the audio waveform received by the at least two microphones.

4. The method of claim 1, wherein making the determination is based on a time-segmented evaluation of audio channels from the at least two microphones.

5. A method of wake-word processing by a wearable electronic device, the method being carried out when the device is worn by a user and the device is in a device sleep state, wherein the device includes a linear microphone array having at least two microphones vertically spaced from each other, and wherein the device further includes a voice recognizer and a host processor, the host processor being in a host-processor sleep state, the method comprising:
receiving, by the at least two microphones of the linear microphone array, an audio waveform representing utterance of a wake word, wherein each microphone of the at least two microphones provides a respective audio channel representing the received audio waveform;
at least one of the microphones passing to the voice recognizer the microphone's respective audio channel representing the received audio waveform, to enable the voice recognizer to determine that the received audio waveform represents utterance of the wake word; and
responsive to the voice recognizer determining that the received audio waveform represents utterance of the wake word, (i) providing to the host processor an interrupt signal to wake the host processor from the host-processor sleep state and (ii) making a determination, by the host processor, based on the respective audio channels from the at least two microphones, of whether to accept the wake-word utterance and wake the device from the device sleep state or rather to reject the wake-word utterance and to go back to sleep,
wherein the host processor makes the determination based on at least one factor selected from the group consisting of (i) an angle of arrival of the audio waveform at the linear microphone array and (ii) an energy level of the audio waveform received by the at least two microphones.

6. The method of claim 5, wherein the linear microphone array has three microphones linearly aligned and vertically spaced from each other including a top microphone, a middle microphone, and a bottom microphone, and wherein the at least two microphones are just a top microphone and the bottom microphone.

7. The method of claim 5, wherein the voice recognizer passes the respective audio channels of the at least two microphones to the host processor to facilitate the host processor making the determination of whether to accept or rather reject the wake-word utterance.

8. The method of claim 5, wherein the host processor makes the determination based at least on the angle of arrival of the audio waveform at the linear microphone array.

9. The method of claim 8, wherein making the determination based on the angle of arrival of the audio waveform at the linear microphone array comprises making the determination based on a comparison of the angle of arrival with a predefined angle-of-arrival threshold.

10. The method of claim 9, further comprising controlling by the host processor, based on the determination, whether (i) to accept the wake-word utterance and wake the device from the device sleep state or rather (ii) to reject the wake-word utterance and to go back to sleep, wherein the controlling comprises:
if the angle of arrival is less than the predefined angle-of-arrival threshold, then accepting by the host processor the wake-word utterance and waking the device from the device sleep state; and
if the angle of arrival is greater than the predefined angle-of-arrival threshold, then rejecting by the host processor the wake-word utterance and going by the host processor back to sleep.

11. The method of claim 5, wherein the host processor makes the determination based at least on the energy level of the audio waveform received by the at least two microphones.

12. The method of claim 11, wherein making the determination based on the energy level of the audio waveform received by the linear microphone array comprises making the determination based on a comparison of the energy level with a predefined energy-level threshold.

13. The method of claim 12, further comprising controlling by the host processor, based on the determination, whether to accept the wake-word utterance or rather to reject the wake-word utterance and wake the device from the device sleep state or rather to reject the wake-word utterance and to go back to sleep, wherein the controlling comprises:
if the energy level is greater than the predefined energy-level threshold, then accepting by the host processor the wake-word utterance and waking by the host processor the device from the device sleep state; and
if the energy level is less than the predefined energy-level threshold, then rejecting by the host processor the wake-word utterance and going by the host processor back to sleep.

14. The method of claim 5, wherein the host processor makes the determination based on a time-segmented evaluation of the respective audio channels.

15. The method of claim 5, wherein the device is worn by the user at a distance of about 5 to 7 inches below a chin of the user.

16. A wearable electronic device comprising:
a battery;
a linear microphone array having at least two microphones;
a processor;
non-transitory data storage; and
program instructions stored in the non-transitory data storage and executable by the processor to carry out operations when the device is worn by a user and is in a sleep state, the operations including:
receiving, by the at least two microphones of the linear microphone array, an audio waveform representing a wake-word utterance,
making a determination, based at least on an angle of arrival of the audio waveform at the at least two microphones of the linear microphone array, of whether to accept the wake-word utterance or rather to reject the wake-word utterance, and
controlling operation of the device based on the determination.

17. The wearable electronic device of claim 16, wherein the device is worn by the user at a distance of about 5 to 7 inches below a chin of the user.

18. The wearable electronic device of claim 16, wherein making the determination of whether to accept or reject the wake-word utterance is further based on an energy level of the audio waveform received by the at least two microphones.

19. The wearable electronic device of claim 16, wherein making the determination is based on a time-segmented evaluation of audio channels from the at least two microphones.

20. A non-transitory computer-readable medium having stored thereon program instructions executable by a processor to cause a wearable electronic device to carry out operations when the device is in a sleep state, the operations including:
receiving, by the at least two microphones of the linear microphone array, an audio waveform representing a wake-word utterance;
making a determination, based at least on an angle of arrival of the audio waveform at the at least two microphones of the linear microphone array, of whether to accept the wake-word utterance or rather to reject the wake-word utterance; and
controlling operation of the device based on the determination.
